(19) United States
(12) Patent Application Publication
(10) Pub. No.: US 2007/0184737 A1
(43) Pub. Date: Aug. 9, 2007

(54) Blended Outer Shell Fabrics

(75) Inventors: Christopher Garrington Frank Corner, Atlanta, GA (US); Stan Jewell, Fayetteville, GA (US)

Correspondence Address: JOHN S. PRATT, ESQ;KILPATRICK STOCKTON, LLP, 1100 PEACHTREE STREET, ATLANTA, GA, 30309, US

(73) Assignee: Southern Mills, Inc., Union City, GA (US)

(21) Appl. No.: 11/737,233

(22) Filed: Apr. 19, 2007

Related U.S. Application Data
(63) Continuation of application No. 10/967,975, filed on Oct. 19, 2004.
(63) Continuation-in-part of application No. 10/715,317, filed on Nov. 17, 2003.
Application No. 10/715,317 is a continuation-in-part of application No. 10/269,213, filed on Oct. 3, 2002.
Application No. 10/269,213 is a continuation-in-part of application No. 10/165,795, filed on Jun. 7, 2002, now abandoned.

(51) Int. Cl. D03D 13/00; D03D 15/00; B32B 5/26

(52) U.S. Cl. 442/203; 442/209; 442/210; 442/224

(57) ABSTRACT

The present disclose relates to blended outer shell fabrics. In one embodiment, an outer shell fabric for use in firefighter turnout gear includes a plurality of yarns that comprise at least three different types of inherently flame resistant fibers. In another embodiment, a fabric includes a blend of inherently flame resistant fibers, the blend including a plurality of para-aramid fibers, a plurality of meta-aramid fibers, and a plurality of polybenzoxazole (PBO) fibers.

### BACKGROUND

Firefighters typically wear protective garments commonly referred to in the industry as turnout gear. Turnout gear normally comprises various garments including, for instance, coveralls, trousers, and jackets. These garments usually include several layers of material including, for example, an outer shell that protects the wearer from flames, a moisture barrier that prevents the ingress of water into the garment, and a thermal barrier that insulates the wearer from extreme heat.

Turnout gear outer shells typically comprise woven fabrics formed of one or two types of flame resistant materials. In addition to shielding the wearer from flames, the outer shells of firefighter turnout gear further provide abrasion resistance and protection from sharp objects. In that the outer shell must withstand exposure to flame and excessive heat, and must be resistant to abrasion and tearing, it must be constructed of a flame resistant material that is both strong and durable.

The selection process for the materials used to construct outer shell fabrics, as with the selection process for other fabrics, often involves balancing various factors. Such factors include fabric performance as well as cost. For instance, outer shell fabrics that primarily comprise lower-performance fibers are normally less expensive than fabrics that include higher-performance fibers. Although the fabrics that comprise higher-performance fibers may provide greater protection, that protection comes at a greater cost, both to the manufacturer and the consumer.

In view of the above, it would be desirable to be able to provide relatively inexpensive outer shell fabrics having performance that approaches or even exceeds that of more expensive outer shell fabrics.

### SUMMARY

The present disclosure relates to blended outer shell fabrics. In one embodiment, an outer shell fabric for use in firefighter turnout gear includes a plurality of yarns that comprise at least three different types of inherently flame resistant fibers.

In another embodiment, a fabric includes a blend of inherently flame resistant fibers, the blend including a plurality of para-aramid fibers, a plurality of meta-aramid fibers, and a plurality of polybenzoxazole (PBO) fibers.

### BRIEF DESCRIPTION OF THE DRAWINGS

The disclosed fabrics can be better understood with reference to the following drawings. The components in the drawings are not necessarily to scale.

FIG. 1 is a rear view of an example protective garment that includes a blended outer shell fabric.

FIG. 2 is a schematic representation of a blended outer shell fabric that can be used in the construction of the garment of FIG. 1.

FIG. 3 is a schematic representation of an alternative blended outer shell fabric that can be used in the construction of the garment of FIG. 1.

### DETAILED DESCRIPTION

As is described in the foregoing, it would be desirable to be able to provide relatively inexpensive outer shell fabrics having improved performance. As is described in the following, such a result can be achieved with certain blends of inherently flame resistant fibers. One such blend, for example, includes a blend of para-aramid, meta-aramid, and polybenzoxazole (PBO) fibers. As is described in greater detail below, such a blend provides unexpectedly desirable physical properties at a relatively low cost.

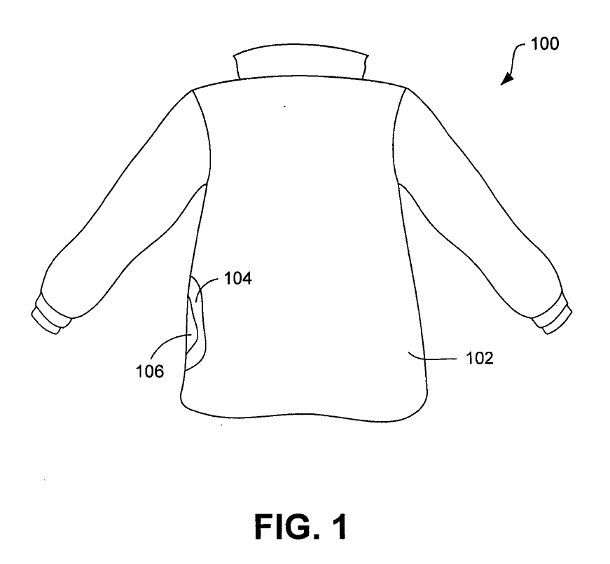

FIG. 1 illustrates an example protective garment 100. More particularly, FIG. 1 illustrates a firefighter turnout coat that can be donned by firefighter personnel when exposed to flames and extreme heat. It is noted that, although a firefighter turnout coat is shown in the figure and described herein, embodiments of this disclosure pertain to protective garments and fabrics generally. Accordingly, the identification of firefighter turnout gear is not intended to limit the scope of the disclosure.

As is indicated in FIG. 1, the garment 100 generally comprises an outer shell 102 that forms the exterior surface of the garment, a moisture barrier 104 that forms an intermediate layer of the garment, and a thermal liner 106 that forms the interior surface (i.e., the surface that contacts the wearer) of the garment. In that it forms the exterior surface of the garment 100, the outer shell 102 preferably is constructed so as to be flame resistant to protect the wearer against being burned. In addition, the outer shell 102 preferably is strong and durable so as to be resistant to abrasion and tearing during use in hazardous environments.

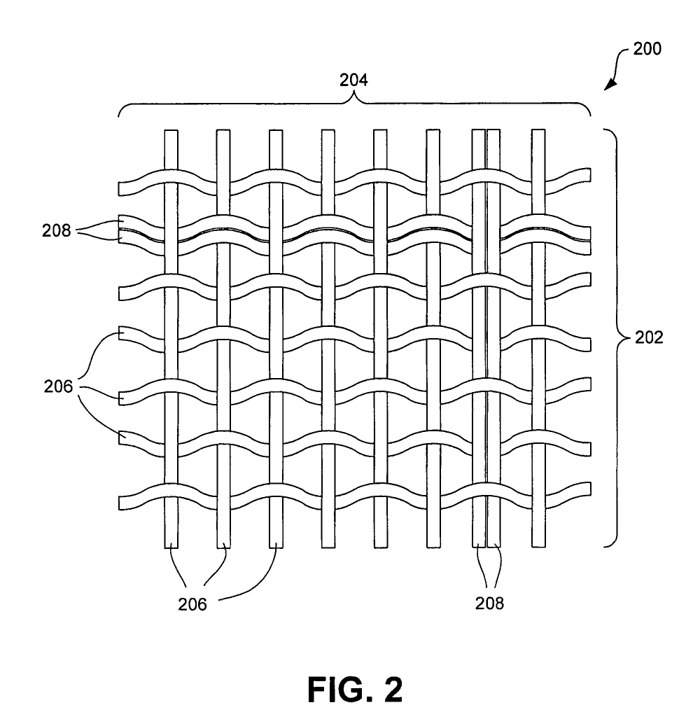

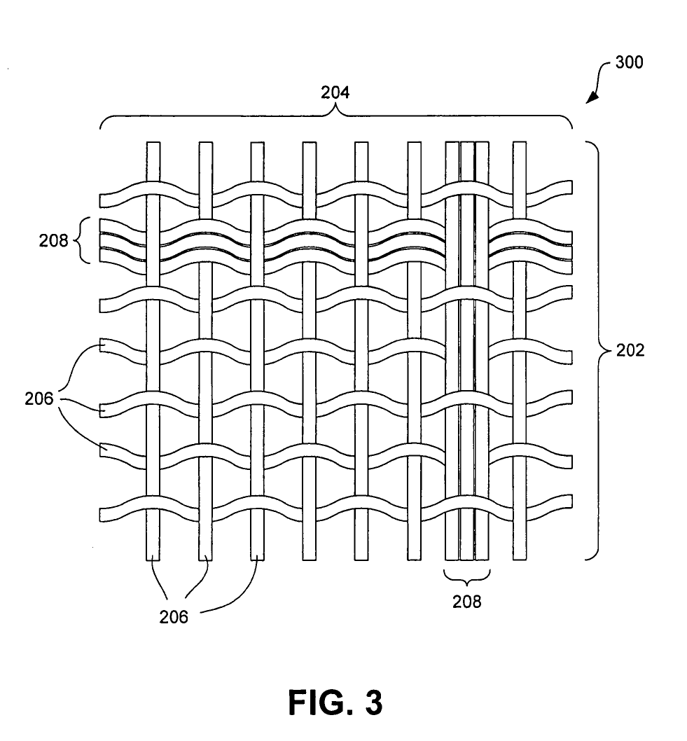

FIG. 2 is a schematic detail view of an example blended outer shell fabric 200 that can be used in the construction of the protective garment 100, and more particularly the outer shell 102 shown in FIG. 1. It is noted, however, that the fabric 200 could be used in the construction of other protective garments either by itself or in combination with other fabrics. The example fabric 200 illustrated in FIG. 2 is a rip stop fabric that comprises a plurality of body yarns 206, including picks 202 and ends 204, and a plurality of rip stop yarns 208. Although a rip stop weave is illustrated in FIG. 2 and is described herein, it will be appreciated that other configurations could be used including, for instance, a plain weave, a twill weave, or a variation on a conventional rip stop weave (see, e.g., FIG. 3).

Generally speaking, the fabric 200 comprises a blend of different inherently flame resistant materials. Typically, at least three different inherently flame resistant materials are used to construct the fabric 200 so as to obtain the distinct benefits of each, whether they be performance or cost benefits. By way of example, the yarns of the fabric 200, including one or more of the picks 202, ends 204, and rip stop yarns 208, comprise a blend of para-aramid fibers, meta-aramid fibers, and PBO fibers.

Example para-aramid fibers include those that are currently available under the trademarks KEVLAR® (DuPont), and TECHNORA® and TWARON® (Teijin). Example meta-aramid fibers include those sold under the tradenames NOMEX T-450® (100% meta-aramid), NOMEX T-455® (a blend of 95% NOMEX® and 5% KEVLAR), and NOMEX T-462® (a blend of 93% NOMEX®, 5% KEVLAR®, and 2% anti-static carbon/nylon), each of which is produced by DuPont. Example meta-aramid fibers also include fibers that are currently available under the trademarks CONEX® and APYEIL®, which are produced by Teijin and Unitika, respectively. Example PBO fibers include ZYLON® from Toyobo®.

It is noted that, for purposes of the present disclosure, when a material name is used herein, the material referred to, although primarily comprising the named material, may not be limited to only the named material. For instance, the term “meta-aramid fibers” is intended to include NOMEX® T-462 fibers, which, as is noted above, comprise relatively small amounts of para-aramid fiber and anti-static fiber in addition to fibers composed of meta-aramid material.

While a tri-blend of para-aramid, meta-aramid, and PBO fibers has been explicitly identified, other inherently flame resistant materials can be added to the blend, if desired. Such other materials may, for example, include one or more of polybenzimidazole (PBI), melamine, polyamide, polyimide, polyimideamide, and modacrylic.

Moreover, non-inherently flame resistant materials can be added to the blend, if desired. Examples of such materials include cellulosic fibers, such as rayon, acetate, triacetate, and lyocell. These cellulosic materials, although not naturally resistant to flame, can be rendered flame resistant, if desired.

In cases in which para-aramid, meta-aramid, and PBO fibers are used to construct the fabric 200, the fabric can, for example, comprise about 40% to about 70% para-aramid, about 10% to about 40% meta-aramid, and about 5% to about 30% PBO. As is described below, one example blend is an approximately 60/20/20 blend of para-aramid fibers, meta-aramid fibers, and PBO fibers, respectively.

The body yarns 206 typically comprise spun yarns that, for example, each comprises a single yarns or two or more individual yarns that are plied, or otherwise combined, together. By way of example, the body yarns 206 comprise one or more yarns that each have a yarn count (or “cotton count”) in the range of approximately 5 to 60 cc, with 8 to 40 cc being preferred. In some embodiments, the body yarns 206 can comprise two yarns that are plied together, each having a yarn count in the range of approximately 10 to 35 cc.

The rip stop yarns 208 can have a construction similar to those of the body yarns, but are provided in pairs that are woven through the fabric 200 side-by-side as is illustrated in FIG. 2. In some embodiments, rip stop yarns 208 can be different in construction from the body yarns 206. For example, filament yarns could be used in the construction of the rip stop yarns 208, if desired. In other embodiments, filament yarns can be combined with spun yarns or spun fiber to form rip stop yarns in the manner described in U.S. patent application Ser. No. 10/165,795, which is hereby incorporated by reference into the present disclosure. In cases in which the rip stop yarns 208 have a construction that is different than the body yarns 206, it is possible to use a single yarn instead of two as is illustrated in FIG. 2. For example, if the rip stop yarns 208 have a lower yarn count (and therefore larger size) than the body yarns 206, then single rip stop yarns 208 may be enough to protect against propagation of fabric tears.

The placement of the rip stop yarns 208 within the fabric 200 can be varied depending upon the desired physical properties. In the embodiment shown in FIG. 2, the rip stop yarns 208 are provided within the fabric 200 in a grid pattern in which several body yarns 206 are placed between each consecutive pair of rip stop yarns 208 in both the warp and filling directions of the fabric. By way of example, a pair of rip stop yarns 208 is provided in the fabric 200 in both the warp and filling directions of the fabric for every approximately 7 to 9 body yarns 206. In some embodiments, the grid pattern is configured to form a plurality of squares. To accomplish this, a greater number of body yarns 206 may need to be provided between consecutive rip stop yarn pairs in the one direction (e.g., warp) as compared to the other direction (e.g., filling).

FIG. 3 is a schematic detail view of an alternative example rip stop fabric 300 that can be used in the construction of the protective garment 100. The fabric 300 is similar to the fabric 200 shown in FIG. 2 and therefore comprises body yarns 206 that form the body of the fabric and that have composition and construction similar to those described above with regard to FIG. 2. In the fabric 300, however, three rip stop yarns 208 are woven through the fabric together in a grid pattern within the fabric body to form a three-end rip stop weave (as opposed to the two-end rip stop weave shown in FIG. 2).

With the constructions described above, the fabrics 200, 300 have weights of about 5 to about 10 ounces per square yard (osy).

As is noted above, unexpected results are achievable with the blends described herein. More specifically, unexpectedly desirable physical properties can be attained given the relatively low cost of the fabric, which is dictated, in substantial part, by the cost of the materials used to produce the fabric. In several instances, the physical properties of the disclosed blends exceed (i.e., are better than) those of competing fabrics and are substantially lower in cost than “top-end” outer shell fabrics. A specific example fabric having a construction within the parameters identified in the foregoing is described in the following.

Example Fabric

A 60/20/20 blend of KEVLAR® T-970 (para-aramid), NOMEX® T-462 (meta-aramid), and ZYLON® (PBO) was constructed having a fabric weight of approximately 7.5 osy. The fabric was formed as a two-end rip stop fabric (see, e.g., FIG. 2) having 56 ends per inch and 51 picks per inch, with 9 ends provided between each pair of rip stop yarns in the warp direction, and 7 picks provided between each pair of rip stop yarns in the filling direction. Each of the yarns in the fabric (i.e., body and rip stop yarns in both directions) comprised two 60/20/20 KEVLAR®/NOMEX®/ZYLON® yarns each having a yarn count of 21 cc (i.e., 21/2 yarns).

Once constructed, the example fabric was tested to determine its physical and thermal properties. The results of the testing are provided in Table I, in which the example fabric is designated as the “Tri-Blend Fabric.” Also included in this table are the test results for other fabrics (“Comparison Fabrics A and B”).

Comparison Fabric A comprised a 60/40 blend of KEVLAR® T-970 and NOMEX® T-462 having a fabric weight of approximately 7.2 osy. The fabric was formed as a three-end rip stop fabric having 56 ends per inch and 51 picks per inch, with 8 ends provided between each group of three rip stop yarns in the warp direction, and 8 picks provided between each group of three rip stop yarns in the filling direction. Each of the yarns in the fabric (i.e., body and rip stop yarns in both directions) comprised two 60/40 KEVLAR®/NOMEX® yarns each having a yarn count of 21 cc (i.e., 21/2 yarns).

Comparison Fabric B comprised a 60/40 blend of KEVLAR® T-970 and PBI having a fabric weight of approximately 7.5 osy. The fabric was formed as a two-end rip stop fabric having 44 ends per inch and 39 picks per inch, with 9 ends provided between each pair of rip stop yarns in the warp direction, and 7 picks provided between each pair of rip stop yarns in the filling direction. Each of the yarns in the fabric (i.e., body and rip stop yarns in both directions) comprised two 60/40 KEVLAR®/PBI yarns each having a yarn count of 15 cc (i.e., 15/2 yarns).

As is indicated in Table I, the example fabric and the comparison fabrics were tested for strength, thermal resistance, and abrasion resistance. In terms of strength, the trap tear strength of the fabrics was tested according to test method ASTM D5733, as is required by NFPA 1971, 2000 edition (hereafter “NFPA 1971”), both before and after 5 washing cycles. In addition, the fabrics were separately tested for tensile strength according to test method ASTM D5034 prior to washing and thermal exposure, after 10 washing cycles, and after thermal exposure.

In terms of thermal resistance, the fabrics were exposed to extreme temperatures for seven (7) seconds in accordance with the thermal protective performance (TPP) test method described in NFPA 1971, and were tested for vertical flame in accordance with Federal Test Method 191A as is required by NFPA 1971.

Finally, the fabrics were tested for abrasion resistance using the Taber Abrasion Test in accordance with ASTM3884.

TABLE I

| | Tri-Blend | Comparison | Comparison |
|---|---|---|---|
| Fabric Properties | Fabric | Fabric A | Fabric B |
| Trap Tear Strength (lbs) | | | |
| Warp | 52.8 | 40.3 | 31.3 |
| Fill | 40.9 | 33.5 | 29.2 |
| Trap Tear Strength (lbs) (5X | | | |
| Wash) | | | |
| Warp | 44 | 34.8 | 28.1 |
| Fill | 36.7 | 25.8 | 25.5 |
| Tensile Strength (lbs) | | | |
| Warp | 435 | 308-305 | 302-260 |
| Fill | 406 | 305-287 | 237-220 |
| Tensile Strength (lbs) (10X | | | |
| Wash) | | | |
| Warp | 313 | 270-237 | 240-237 |
| Fill | 321 | 260-215 | 205-172 |
| Tensile Strength (lbs) | | | |
| (after 7 sec TPP exposure) | | | |
| Warp | 223 | 78-75 | 117-105 |
| Fill | 187 | 90-73 | 85 |
| TPP (cal/cm2) | | | |
| Crosstech ®/Caldura ® | 40.6 | 38.4 | 41.2 |
| Platinum SLNew | | | |
| Crosstech ®/Caldura ® | 44 | 39.8 | 39.7 |
| Platinum | | | |
| Crosstech ®/3 layer E89 ® | 44.3 | 47.1 | 41.1 |
| Crosstech ®/Q9 ® | 50 | 48.9 | 47.8 |
| Vertical Flame | | | |
| After Flame (sec) (W × F) | 0 × 0 | 0 × 0 | 0 × 0 |
| Char Length (inch) (W × F) | 0.5 × 0.6 | .54 × .43 | .29 × .24 |
| Taber Abrasion | | | |
| (average cycles to first break) | 933 | 350 | 367 |

As is evident from Table I, the example fabric (“Tri-Blend Fabric”) performed markedly better in terms of both trap tear strength and tensile strength than Comparison Fabrics A and B. Although improved performance could be expected over Comparison Fabric A due to the presence of the PBO fiber in the Tri-Blend Fabric, the magnitude of the strength increases resulting from only 20% PBO fiber is particularly surprising. For instance, the tensile strength of the Tri-Blend Fabric tested to be as much as over 250% greater than that of Comparison Fabric A.

Equally or even more surprising is the strength that the Tri-Blend fabric exhibited after 7 seconds of TTP exposure as compared to Comparison Fabric B. As is evident from the table, the Tri-Blend fabric was approximately twice as strong as Comparison Fabric B after such exposure. This strength difference was unexpected at least in part because Comparison Fabric B contained a significant amount of PBI, which is generally regarded as much more resistant to thermal exposure than less expensive materials, such as the meta-aramid of the Tri-Blend fabric.

In addition, marked improvement in abrasion resistance was observed for the Tri-Blend Fabric. As is indicated in Table I, the Tri-Blend Fabric exhibited an abrasion resistance that is nearly three times that of Comparison Fabrics A and B.

Notably, the above-described high strength and abrasion resistance is achievable with a fabric that is significantly cheaper to produce than many high-end fabrics, such as Comparison Fabric B, which comprises relatively costly PBI fiber. Therefore, a high-strength, abrasion-resistant, and flame resistant fabric can be produced at a relatively low cost.

While particular embodiments of fabrics have been disclosed in detail in the foregoing description and drawings for purposes of example, it will be understood by those skilled in the art that variations and modifications thereof can be made without departing from the scope of the disclosure.

1-28. (canceled)

29. A fabric comprising a plurality of yarns, wherein at least some of the yarns each comprises a blend of at least three different types of inherently flame resistant fibers.

30. The fabric of claim 29, wherein the blend comprises para-aramid fibers, meta-aramid fibers, and polybenzoxazole (PBO) fibers.

31. The fabric of claim 30, wherein the fabric comprises about 40% to about 70% para-aramid fibers, about 10% to about 40% meta-aramid fibers, and about 5% to about 30% polybenzoxazole (PBO) fibers.

32. The fabric of claim 31, wherein the fabric comprises about 60% para-aramid fibers, about 20% meta-aramid fibers, and about 20% polybenzoxazole (PBO) fibers.

33. The fabric of claim 29, wherein the fabric comprises a rip stop weave.

34. The fabric of claim 33, wherein the rip stop weave is a two-end rip stop weave.

35. The fabric of claim 29, wherein the at lease some of yarns comprise yarn counts in the range of approximately 10-35 cc.

36. The fabric of claim 29, wherein the fabric has a weight of about 5 ounces per square yard to about 10 ounces per square yard.

37. The fabric of claim 29, wherein the fabric has a tensile strength in the warp direction that exceeds 200 pounds and a tensile strength in the filling direction that exceeds 175 pounds after a 7 second exposure in accordance with the thermal protective performance (TPP) test method defined in NFPA 1971, 2000 edition.

38. The fabric of claim 29, wherein each of the plurality of yarns in the fabric comprises the blend.

39. A garment comprising the fabric of claim 29.

40. A firefighter turnout garment, the garment comprising:
a thermal liner that forms an interior surface of the garment;
a moisture barrier that forms an intermediate layer of the garment; and
an outer shell that forms the exterior surface of the garment, the outer shell comprising a fabric comprising a plurality of yarns, wherein at least some of the yarns each comprises a blend of para-aramid fibers, meta-aramid fibers, and polybenzoxazole (PBO) fibers.

41. The garment of claim 40, wherein the outer shell fabric comprises about 40% to about 70% para-aramid fibers, about 10% to about 40% meta-aramid fibers, and about 5% to about 30% PBO fibers.

42. The garment of claim 41, wherein the outer shell fabric comprises about 60% para-aramid fibers, about 20% meta-aramid fibers, and about 20% polybenzoxazole (PBO) fibers.

43. The garment of claim 40, wherein the outer shell fabric comprises a rip stop weave.

44. The garment of claim 43, wherein the rip stop weave is a two-end rip stop weave.

45. The garment of claim 40, wherein each of the plurality of yarns in the fabric comprises the blend.

46. The garment of claim 40, wherein the at least some of the yarns comprise yarn counts in the range of approximately 10-35 cc.

47. The garment of claim 40, wherein the outer shell fabric has a weight of about 5 ounces per square yard to about 10 ounces per square yard.

48. The garment of claim 40, wherein the garment comprises at lease one jacket, trousers, or coveralls.
